(19) United States
(12) Patent Application Publication
(10) Pub. No.: US 2026/0311506 A1
(43) Pub. Date: Oct. 8, 2026

(54) COMPANION ANIMAL BIOLOGICAL INFORMATION ACQUISITION METHOD AND ELECTRONIC DEVICE FOR CONDITIONALLY DETECTING BEHAVIOR INFORMATION ABOUT PERSON AND BIOLOGICAL INFORMATION ABOUT COMPANION ANIMAL TOGETHER

(71) Applicant: PETNOW INC., Seoul (KR)

(72) Inventors: Dae Hyun PAK, Seoul (KR); Joon Ho LIM, Goyang-si (KR)

(73) Assignee: PETNOW INC., Seoul (KR)

(21) Appl. No.: 19/483,305

(22) PCT Filed: Nov. 24, 2023
(86) PCT No.: PCT/KR2023/019053

§ 371 Date: Nov. 11, 2025

(30) Foreign Application Priority Data
May 12, 2023 (KR) 10-2023-0061622

(51) Int. Cl. G06V 40/10; A01K 29/00; G06V 40/16; G06V 40/18; G06V 40/20

(52) U.S. Cl. CPC G06V 40/10; A01K 29/007; G06V 40/174; G06V 40/18; G06V 40/20

(57) ABSTRACT

The present invention provides a method for acquiring behavior information about the face and body of a person (owner of a companion animal) together with biological feature information about the companion animal when acquiring the biological feature information about the companion animal using a camera. The companion animal biological information acquisition method of an electronic device for conditionally detecting behavior information about a person together and biological information about a companion animal together according to the present invention, comprises: a step for capturing images including the person and the companion animal via a camera included in the electronic device; a step for outputting the images via a display; a step in which a processor extracts the behavior information about the person and the biological information about the companion animal from the images; a step in which the processor determines the suitability of the images on the basis of the behavior information about the person and the biological information about the companion animal; and a step for storing the behavior information and the biological information on a memory when it is determined that the images are suitable.

### TECHNICAL FIELD

The present disclosure relates to a method and an electronic device for acquiring behavior information of a human such as a facial expression or a gaze direction of the human who raises a companion animal and acquiring biometric information of the companion animal such as a nose print or a facial shape of the companion animal simultaneously according to whether a specific condition is satisfied.

### BACKGROUND ART

In modern society, there is an increasing demand for companion animals that can provide emotional support while the companion animals live together with humans. For various additional services such as life cycle management and health management of the companion animals, there is an increasing need to store and manage information on the companion animals in a database. Such management requires identification information of each companion animal, and an object used for identification may be defined according to the type of companion animal. For example, similar to a human fingerprint, a nose print (the pattern of nose wrinkles) of a dog is known to be unique to each individual dog, and it is generally known that when a dog reaches adulthood (about six months old), this characteristic remains unchanged throughout the remainder of the life of the dog. Accordingly, the nose print of the dog may be used as a means for identification of the dog.

However, unlike a human who can assume a specific posture or can use various sensors, it is difficult to make a companion animal maintain a specific posture or to use a sensor on the animal. Since a verbal communication between a human and a companion animal is impossible, it might be considered to forcibly fix the animal in a particular posture or bring the animal into contact with a sensor by using a physical force or using a restraining frame. However, this is undesirable in terms of protecting the rights of the companion animal and avoiding repulsion from the owner of the companion animal. In addition, since a person is needed to hold the companion animal and another person is needed to operate a device for acquiring biometric information of the animal, there is a practical problem that it is difficult for a single person to acquire biometric information of the companion animal alone.

As humans and animals coexist in modern society, a situation in which it is necessary to associate information of the companion animal with information of the owner of the companion animal frequently arises. For example, when a human enters a companion animal facility or retrieves a companion animal from a foster facility (such as an animal hotel), the facility has no means to verify whether the human is the legitimate owner of the companion animal. In cases of abandonment, it frequently occurs that people deny that the companion animal is their own.

### DISCLOSURE

### Technical Problem

Accordingly, the present disclosure is intended to provide a method for acquiring biometric feature information of a companion animal together with a behavior information of the face and the body of a human (an owner of the companion animal) while the biometric feature information of the companion animal is acquired by using a camera.

Accordingly, when capturing an image for biometric recognition of the companion animal is performed, an image more suitable for identification or training may be acquired. In addition, according to the present disclosure, identification of the companion animal may be more conveniently performed, and a solution to ownership disputes and ownership denials of the companion animal that may occur in a specific situation may be provided.

The problems to be solved of the present disclosure are not limited to those mentioned above, and other problems not mentioned will be clearly understood by those skilled in the art from the following description.

### Technical Solution

According to the present disclosure, there is provided a companion animal biometric information acquisition method for conditionally detecting behavior information of a human and biometric information of a companion animal simultaneously by using an electronic device, the companion animal biometric information acquisition method including: capturing an image containing the human and the companion animal by using a camera provided in the electronic device; outputting the image through a display; extracting the behavior information of the human and the biometric information of the companion animal from the image by using a processor; determining, on the basis of the behavior information of the human and the biometric information of the companion animal, whether the image is appropriate by using the processor; and storing the behavior information and the biometric information in a memory when the image is determined to be appropriate.

According to an aspect of the present disclosure, the capturing of the image may include capturing the image containing the human and the companion animal primarily by a front camera capturing the image in a direction facing a display direction of the display.

According to an aspect of the present disclosure, the companion animal biometric information acquisition method may further include capturing the image by using a rear camera provided on a side opposite to the front camera instead of using the front camera when the front camera is not capable of being activated.

According to an aspect of the present disclosure, whether the front camera is capable of being activated may be determined on the basis of property information of the front camera, and the property information may include whether a manual focus function is supported, a capturing format, and a capturing size.

According to an aspect of the present disclosure, the determining of whether the image is appropriate may include determining, on the basis of a facial expression or a gaze direction of the human, whether the image is appropriate.

According to an aspect of the present disclosure, the image may be determined to be appropriate when the facial expression of the human is determined to be a smiling expression or a neutral expression, and the image may be determined to be inappropriate when the facial expression is determined to be other than the smiling expression or the neutral expression.

According to an aspect of the present disclosure, the determining of whether the image is appropriate may include evaluating a quality of a feature region containing the biometric information of the companion animal in the image.

According to an aspect of the present disclosure, the quality may include a sharpness, a brightness, and a size.

According to an aspect of the present disclosure, an evaluation condition for the quality may be set differently according to whether the camera is a front camera capturing the image in a direction facing a display direction of the display or a rear camera provided on a side opposite to the front camera.

According to the present disclosure, there is provided an electronic device for conditionally detecting behavior information of a human and biometric information of a companion animal simultaneously, the electronic device including: a camera configured to capture an image; a display configured to visually output the image; a processor functionally coupled to the camera and the display; and a memory functionally coupled to the processor. The processor may be configured to capture the image containing the human and the companion animal by using the camera, to output the image through the display, to extract the behavior information of the human and the biometric information of the companion animal from the image, to determine, on the basis of the behavior information of the human and the biometric information of the companion animal, whether the image is appropriate, and to store the behavior information and the biometric information in the memory when the image is determined to be appropriate.

### Advantageous Effects

According to the present disclosure, in the acquiring of the image for biometric recognition of the companion animal, the quality evaluation of the image reflecting the behavior information of the human is performed so as to determine whether to acquire the image, so that an image more suitable for training or identification is capable of being acquired.

In addition, the behavior information of the human and the biometric information of the companion animal may be acquired simultaneously, and temporal and spatial synchronization may be ensured. Through this, a correlation between the behavior information of the human and the biometric information of the companion animal is established, and a multi-factor authentication process is capable of being performed.

### DESCRIPTION OF DRAWINGS

FIG. 1 shows an appearance of an electronic device according to the present disclosure.

FIG. 2 is a block diagram illustrating a configuration of the electronic device according to the present disclosure.

FIG. 3 is a view illustrating a system including the electronic device that acquires biometric information of a companion animal and a server that processes the biometric information.

FIG. 4 is a flowchart illustrating a companion animal biometric information acquisition method for detecting behavior information of a human and biometric information of a companion animal simultaneously.

FIG. 5 is a view illustrating a process of acquiring behavior information of a human and biometric information of a companion animal.

FIG. 6 and FIG. 7 are views illustrating examples of screens displayed in the process of acquiring the behavior information of the human and the biometric information of the companion animal.

FIG. 8 and FIG. 9 are flowcharts illustrating a process of selecting a camera capturing an image for acquiring behavior information of a human and biometric information of a companion animal.

FIG. 10 is a view illustrating an example of an interface for selecting a camera to perform image capturing.

FIG. 11 is a flowchart illustrating a process of inspecting the suitability of behavior information of a human and biometric information of a companion animal.

FIG. 12 is a flowchart illustrating a process of inspecting the suitability of behavior information of a human.

FIG. 13 and FIG. 14 are views illustrating examples of a capturing guide interface according to a result of the suitability inspection in the process of acquiring behavior information of a human and biometric information of a companion animal.

### MODE FOR INVENTION

Hereinafter, exemplary embodiments of the present disclosure will be described in detail with reference to the accompanying drawings so that those skilled in the art can easily implement the present disclosure. The present disclosure is not limited to the exemplary embodiments described herein and may be embodied in many different forms.

In order to clearly describe the present disclosure, parts irrelevant to the description are omitted, and the same reference numerals designate the same or similar components throughout the specification.

In addition, in various exemplary embodiments, components having the same configuration will be described only in representative exemplary embodiments by using the same reference numerals, and in other exemplary embodiments, only configurations different from the representative exemplary embodiments will be described.

Throughout the specification, when a part is said to be “connected (or coupled) ” to another part, an expression such as “connected (or coupled) ” is intended to include not only “directly connected (or coupled)” but also “indirectly connected (or coupled) ” having a different member interposed therebetween. In addition, it will be further understood that when a part “comprises”, “includes”, or “has” an element, this means that other elements are not excluded but may be further included, unless otherwise stated.

Unless defined otherwise, all terms used herein including technical or scientific terms have the same meanings as generally understood by a person having ordinary knowledge in the art to which the present disclosure pertains. The terms defined in general dictionaries are construed as having meanings consistent with the contextual meanings of the art, but not interpreted as ideal meanings or excessively formal meanings unless explicitly defined in the present application.

Hereinafter, a companion animal £ biometric information acquisition method for conditionally detecting human HM behavior information and companion animal PT biometric information simultaneously and an electronic device 1 configured to perform the method will be described. Biometric information of a companion animal PT is acquired for identity verification of the companion animal PT. The biometric information of the companion animal PT may include iris information, facial shape information, body shape information, and nose wrinkle pattern (nose print) information. Although the present specification mainly describes capturing the nose print of a dog and the face of a cat as the biometric information of the companion animal PT, the scope of the companion animal PT is not limited to a dog or a cat, and the biometric information used for identification is not limited to the nose print and various physical characteristics of the companion animal PT may be used.

According to the present disclosure, an electronic device 1 captures the companion animal PT by using a camera 10, and acquires biometric information of the companion animal PT from the captured image. The electronic device 1 may be a mobile device such as a smartphone or a tablet. Alternatively, the electronic device 1 may be a computing device (for example, a laptop or desktop computer). In a mobile device such as a foldable phone capable of being folded and unfolded, respective front cameras 11 may be present both before the mobile device is folded and after the mobile device is folded. In the electronic device 1 according to the present disclosure, the front camera 11 may be provided inside a display 20 or may be provided outside the display 20.

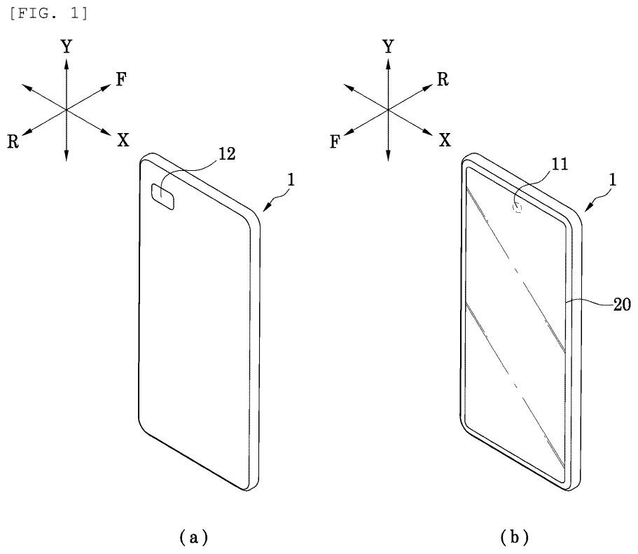

FIG. 1 shows an example of the electronic device 1 in which the front camera 11 is mounted inside a display region. FIG. 1(a) shows a front side F of the electronic device 1 in which the front camera 11 is mounted inside the display region, and FIG. 1(b) shows a rear side R of the electronic device 1. The appearance of the electronic device 1 may include a frame, the display 20, and the camera 10 (including the front camera 11 and a rear camera 12). In FIG. 1, the front camera 11 may be provided inside a screen region of the display 20. Each of the front camera 11 and the rear camera 12 may be provided as a plurality of cameras. Meanwhile, the front camera 11 may also be mounted outside the display region.

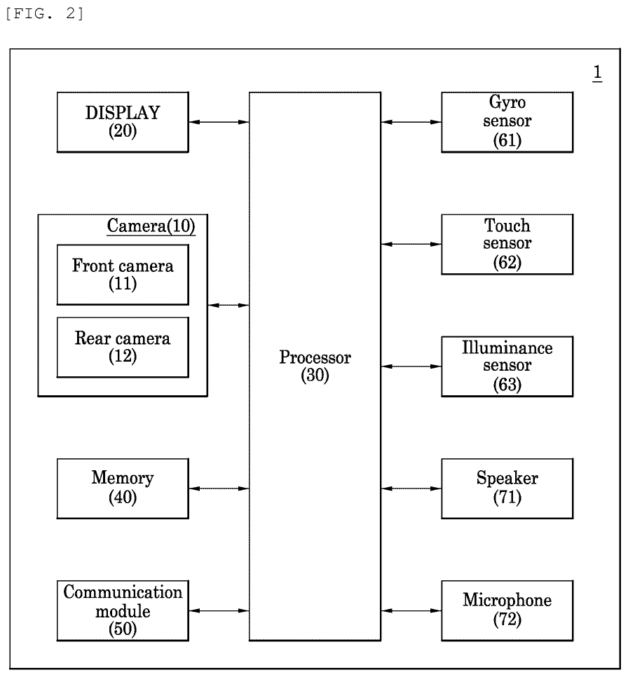

Referring to FIG. 2, the electronic device 1 includes the camera 10, the display 20, a processor 30, and a memory 40. Optionally, the electronic device 1 may further include a gyro sensor 61, a touch sensor 62, or an illuminance sensor 63. Optionally, the electronic device 1 may further include a communication module 50, a speaker 71, or a microphone 72.

The display 20 is a device configured to output visual information. The display 20 may include a panel and a control circuit. The touch sensor 62 may be disposed on the panel. Particularly, the display 20 may output an image (a preview image or a captured frame) of the companion animal PT being captured. In addition, the display 20 may output an interface providing information to a user during a process of acquiring biometric information of the companion animal PT.

The camera 10 is a device configured to capture an image (a still image or a video). The camera 10 may include at least one image sensor, a lens, a camera controller, an image processing processor, and a flash. The camera 10 may include the front camera 11 and the rear camera 12. The camera 10 may capture an image for acquiring biometric information of the companion animal PT and behavior information of a human HM. Characteristics (for example, focus and exposure) of the camera 10 may be controlled so that a feature object for acquiring the biometric information of the companion animal PT is capable of being appropriately identified. The front camera 11 is a camera configured to capture an image in a direction toward a display direction of the display 20, and the rear camera 12 is a camera configured to capture an image in a direction toward a direction opposite to the display direction of the display 20 as illustrated in FIG. 1. The camera 10 may include not only an internal camera mounted in the electronic device 1 but also an external camera connected to the electronic device 1 in a wired or wireless manner.

The processor 30 may perform computation and data processing for performing an operation of the electronic device 1, and may control each module of the electronic device 1. The processor 30 may execute at least one software program stored in the memory 40. The processor 30 may include a general purpose processor (for example, a CPU or an AP) configured to execute an operating system for managing overall operations of the electronic device 1. In addition, the processor 30 may include a dedicated processor (for example, a GPU or an NPU) for performing specific computational processing. The processor 30 may include at least one processing circuit. The processor 30 may perform a data processing and control operation for acquiring biometric information of the companion animal PT and behavior information of the human HM.

The memory 40 may store an operating system for operating the electronic device 1, a program such as an application, and data used during execution of the program. The memory 40 may include a volatile memory (for example, a DRAM) and a non-volatile memory (for example, a flash memory). The memory 40 may store an image for biometric recognition of the companion animal PT. In addition, the memory 40 may store, together with the image, biometric information of the companion animal PT and behavior information of the human HM.

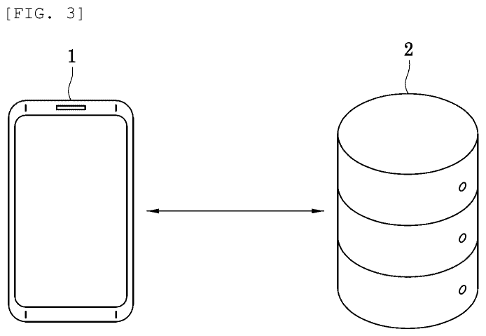

The communication module 50 provides an environment in which the electronic device 1 is capable of communicating with an external entity (for example, a server, a base station, an IoT device, or a mobile device). The communication module 50 may include an antenna, an RF circuit, and a communication processor. The communication module 50 may provide data received from the external entity to the processor 30. The communication module 50 may convert data provided from the processor 30, and may transmit the converted data to the external entity. The communication module 50 may receive image data for biometric authentication of the companion animal PT provided from the processor 30, and may transmit the image data to a server 2. As illustrated in FIG. 3, the electronic device 1 may communicate with the server 2. The electronic device 1 may acquire biometric information of the companion animal PT, and may transmit the acquired biometric information to the server 2. The server 2 may store the biometric information in the database. The server 2 may perform data processing for training or identifying the companion animal PT by using the biometric information. The server 2 may generate identification information of the companion animal PT from the biometric information and the behavior information of the human HM, and may transmit the identification information of the companion animal PT to the electronic device 1.

The electronic device 1 for acquiring biometric information of the companion animal PT according to the present disclosure includes the camera 10 configured to capture an image, the display 20 configured to visually output the image, the processor 30 functionally coupled to the camera 10 and the display 20, and the memory 40 functionally coupled to the processor 30.

The processor 30 is configured to capture an image of the human HM and the companion animal PT through the camera 10, to output the image through the display 20, to extract behavior information of the human HM and biometric information of the companion animal PT from the image, to determine whether the image is suitable on the basis of the behavior information of the human HM and the biometric information of the companion animal PT, and to store the behavior information and the biometric information in the memory 40 together with the image when the image is determined to be suitable.

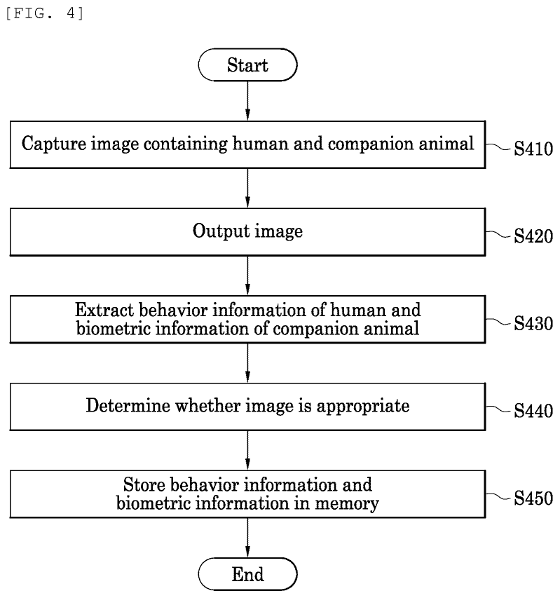

FIG. 4 is a flowchart illustrating the companion animal PT biometric information acquisition method for conditionally detecting behavior information of the human HM and biometric information of the companion animal PT simultaneously. According to the present disclosure, the companion animal PT biometric information acquisition method for conditionally detecting the behavior information of the human HM and the biometric information of the companion animal PT simultaneously includes: capturing an image including the human HM and the companion animal PT through the camera 10 provided in the electronic device 1 S410; outputting the image through the display 20 S420; extracting the behavior information of the human HM and the biometric information of the companion animal PT from the image S430; determining whether the image is appropriate on the basis of the behavior information of the human HM and the biometric information of the companion animal PT S440; and storing the behavior information and the biometric information in the memory 40 when the image is determined to be appropriate S450. The capturing of the image, the extraction of the human behavior information and the animal biometric information, and the suitability determination according to the present disclosure may be performed for each frame, or may be repeatedly performed at a predetermined frame interval or a predetermined time interval.

According to the present disclosure, when the image for biometric recognition of the companion animal PT is captured, the behavior information of the human HM is considered together in determining whether the image is suitable for recognition or training. For example, when the expression of the human HM is an embarrassed expression or when a gaze direction of the human HM is not facing toward a frontward, it is highly probable that capturing the image with the companion animal PT is not in a prepared state. When the capturing is not prepared, the companion animal PT is also likely not to face the frontward or is likely to move its head. In this state, when the capturing is performed, the probability of capturing an image having a suitable quality is low.

Therefore, in determining whether to acquire the image, the behavior information of the human HM is analyzed, and whether the behavior information satisfies the condition for acquiring the image is determined. Furthermore, when the behavior information satisfies the condition for acquiring the image and other acquisition conditions, it is determined that the image is suitable for biometric recognition of the companion animal PT, so that the image may be stored.

In addition, the image in which the companion animal PT and the human HM are captured together may be used to identify the owner of the companion animal PT. Accordingly, in capturing the image for biometric recognition of the companion animal PT, the companion animal PT and the human HM are captured together, so that information about the owner is capable of being used together as information for identification of the companion animal PT.

According to the present disclosure, in determining whether the image is suitable for identification of the companion animal PT during the process of acquiring the image for biometric recognition of the companion animal PT, a feature object (for example, the face, the nose, or the eyes) for biometric recognition of the companion animal PT and the behavior information of the human HM captured together are considered simultaneously. When the companion animal PT and the human HM are captured together, the suitability inspection for the feature object of the companion animal PT and the suitability inspection for the human HM may be performed simultaneously in order to determine whether the captured image is suitable for identifying the companion animal PT. The inspection for the feature object of the companion animal PT may be performed by evaluating the clarity, the brightness, and the size of the image including the feature object. The inspection for the feature object of the human HM may be performed in a manner similar to that for the companion animal PT. In addition, the inspection for the feature object of the human HM includes confirming that the human HM is capturing an image for biometric recognition of the companion animal PT through the facial expression and the gaze direction of the human HM.

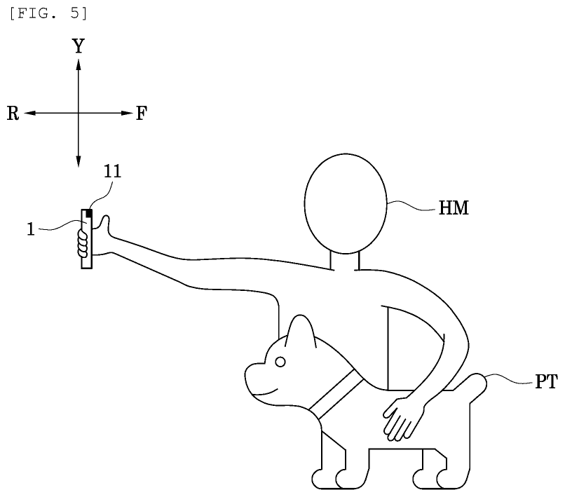

In the process S410, an application for biometric recognition of the companion animal PT is executed, the camera 10 is activated, and image capturing is initiated. As the camera 10 for capturing an image, the front camera 11 or the rear camera 12 may be used. As illustrated in FIG. 5, the front camera 11, which is suitable for photographing the human HM and the companion animal PT together, may preferably be used first. That is, the process S410 of capturing the image may include a process of capturing an image of the human HM and the companion animal PT with the front camera 11 that captures an image facing the display direction of the display 20.

As illustrated in FIG. 5, the process of acquiring biometric information of the companion animal PT using the front camera 11 may be performed by capturing the companion animal PT while the human HM (user) holds the electronic device 1. Comparing to the case where the rear camera 12 is used, using the front camera 11 to capture the image for acquiring biometric information of the companion animal PT provides various advantages. Generally, a companion animal such as a dog does not recognize being captured, so that the companion animal looks in other directions without facing the camera. In addition, since most companion animals tend to continuously move their heads without remaining still, it is very difficult to capture a frontal image suitable for biometric identification. Furthermore, since most users are not skilled in capturing, it is difficult for the users to capture an image suitable for biometric recognition of a companion animal.

On the other hand, when the companion animal PT is captured using the front camera 11 as illustrated in FIG. 5, the user can check the image of the companion animal PT being captured in real time, so that the image in a form more suitable for biometric recognition may be acquired. In addition, since the user may capture the companion animal PT while the user holds the companion animal and both the user and the companion animal are in a more comfortable state during capturing, an image in a form more suitable for biometric recognition may be acquired.

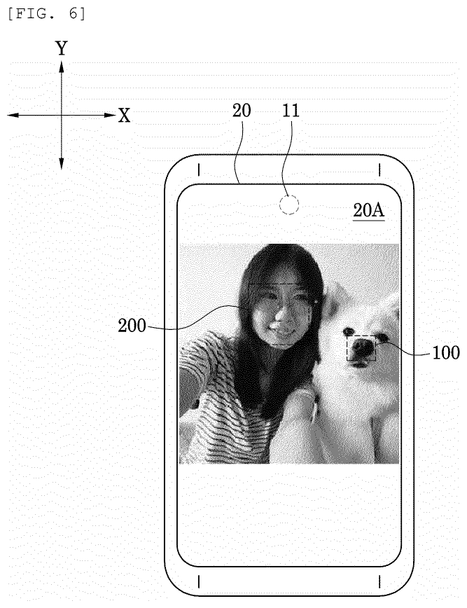

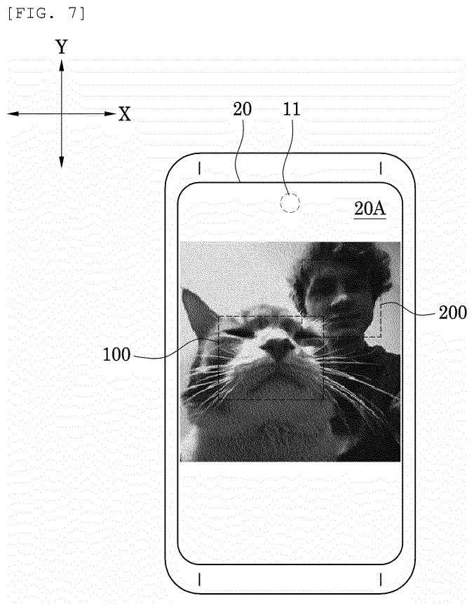

FIG. 6 and FIG. 7 are views illustrating examples of screens displayed in the process of acquiring the behavior information of the human HM and the biometric information of the companion animal PT. FIG. 6 is a view illustrating a screen in which a human and a dog are captured together, and FIG. 7 is a view illustrating a screen in which a human and a cat are captured together. As illustrated in FIG. 6, when the human and the dog are captured together, the nose of the dog is used as a feature object, and an animal feature region 100 including the feature object is extracted. In addition, the face of the human is used as a feature object, and a human feature region 200 including the feature object is extracted. As illustrated in FIG. 7, when the human and the cat are captured together, the face of the cat is used as a feature object, and an animal feature region 100 including the feature object is extracted. In addition, the face of the human is used as a feature object, and a human feature region 200 including the feature object is extracted.

In order to acquire biometric information of the companion animal PT, the front camera 11 may capture the face of the companion animal PT. Before capturing using the front camera 11, the processor 30 may determine whether the front camera 11 is capable of being activated. That is, the processor 30 may determine whether to capture an image for acquiring biometric information of the companion animal PT by using the front camera 11. When the front camera 11 is capable of being activated, the processor 30 activates the front camera 11. When the front camera 11 is not capable of being activated, the processor 30 activates the rear camera 12 provided on the opposite side of the front camera 11 instead.

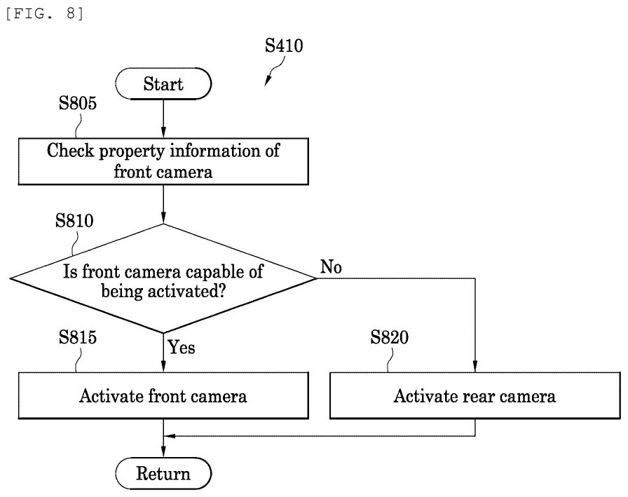

As illustrated in FIG. 8, capturing an image containing the person HM and the companion animal PT S410 includes: checking property information of the front camera 11 S805; determining, on the basis of the property information, whether the front camera 11 is capable of being activated S810; activating the front camera 11 when the front camera 11 is capable of being activated S815; and activating the rear camera 12 provided on the opposite side of the front camera 11 when the front camera 11 is not capable of being activated S820.

According to another embodiment, the user may select which camera to use. According to the present disclosure, the processor 30 checks the property information of the front camera 11 and determines, on the basis of the property information, whether the front camera 11 is capable of being activated. The property information of the front camera 11 may include whether a manual focus function is supported, a capturing format, a capturing size, and hardware level information. The property information of the front camera 11 may be stored as data of a camera management program. For example, in a situation in which the front camera 11 is a camera supporting the manual focus function, the capturing format and the capturing size satisfy a preset condition, and the hardware level of the front camera 11 satisfies a reference level, the processor 30 may determine that the front camera 11 is a camera capable of being used for acquiring biometric information of the companion animal.

The processor 30 may output, through the display 20, the property information of the front camera 11 and whether the front camera 11 is capable of being activated. By displaying the property information of the front camera 11 and whether the front camera 11 is capable of being activated, the user may check whether the front camera 11 is capable of being used for acquiring biometric information of the companion animal.

When the front camera 11 is not capable of being activated, the processor 30 may activate the rear camera 12. That is, the processor 30 may capture an image for biometric recognition of the companion animal by using the rear camera 12 without activating the front camera 11.

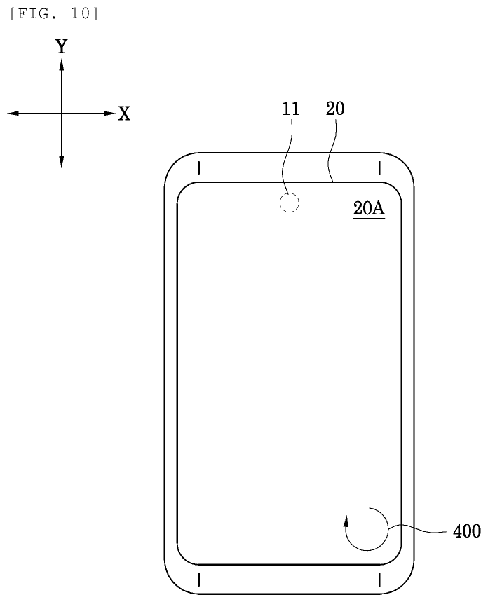

When the front camera 11 is capable of being activated, the processor 30 may output an interface allowing a selection between the front camera 11 and the rear camera 12. For example, when the front camera 11 is capable of being activated, the processor 30 may output an interface that allows the user to select the front camera 11. For example, while the rear camera 12 is activated by default to display a preview image, an icon 400 for switching the camera may be displayed at a lower right end of the screen of the application as illustrated in FIG. 10. When a touch input on the icon 400 is detected by the touch sensor 62, the processor 30 activates the front camera 11 and displays an image captured by the front camera 11 to the display 20 as a preview image. When a touch input on the icon 400 is detected again during capturing by the front camera 11, the processor 30 outputs an image captured by the rear camera 12 to the display 20 as the preview image. As another example, before capturing starts, a list allowing the user to select either the front camera 11 or the rear camera 12 may be displayed.

When the front camera 11 is selected, the processor 30 activates the front camera 11, and acquires an image for biometric recognition of the companion animal. When the rear camera 12 is selected, the processor 30 activates the rear camera 12, and acquires an image for biometric recognition of the companion animal.

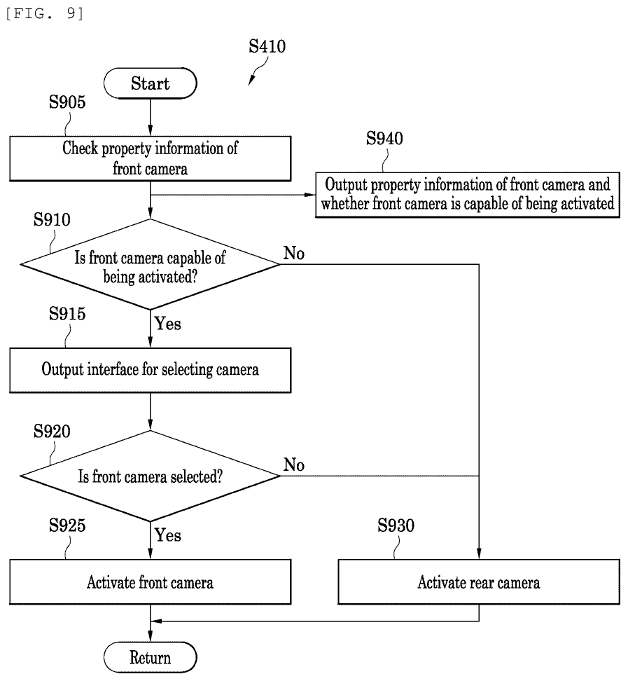

As illustrated in FIG. 9, the process S410 of capturing the image containing the human HM and the companion animal PT includes checking the property information of the front camera 11 S905 and determining, on the basis of the property information of the front camera 11, whether the front camera 11 is capable of being activated S910. In addition, outputting, through the display 20, the property information of the front camera 11 and whether the front camera 11 is capable of being activated S940 may be performed. When the front camera 11 is capable of being activated, outputting the interface allowing selection between the front camera 11 and the rear camera 12 S915 may be performed. Then, determining whether the front camera 11 is selected through the interface S920, activating the front camera 11 when the front camera 11 is selected S925, and activating the rear camera 12 when the front camera 11 is not selected S930 are performed. Thereafter, capturing the image for biometric recognition of the companion animal through the selected camera may be performed.

When the image is captured, biometric information of the companion animal PT and behavior information of the human HM are extracted from a frame of the captured image. The biometric information of the companion animal PT may be extracted from the feature region 100 of the companion animal PT, and the behavior information of the human HM may be extracted from the feature region 200 of the human HM. As a condition for extracting the biometric information of the companion animal PT, the suitability determination may be performed for the quality of the feature region 100 and for the behavior information of the human HM.

According to the present disclosure, in determining whether the captured image is suitable for biometric recognition of the companion animal, a quality inspection of the animal feature region 100 and the inspection for the human feature region 200 are performed together. The inspection for the human feature region 200 may include a quality inspection such as a clarity inspection, a size inspection, and a brightness inspection, and may include an inspection of the behavior information of the human HM. The behavior information of the human HM includes facial expression information and gaze direction information.

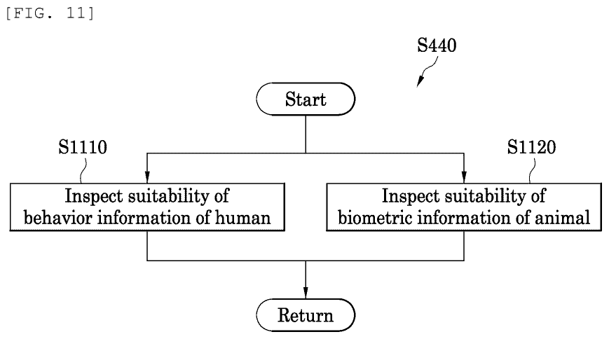

FIG. 11 is a flowchart illustrating a process of inspecting the suitability of the behavior information of the human HM and the biometric information of the companion animal PT. As illustrated in FIG. 11, when an image is captured, performing the suitability inspection on the behavior information of the human HM S1110 and performing the suitability inspection on the biometric information of the companion animal PT S1120 may be performed.

The process of performing the suitability inspection on the behavior information of the human HM may include determining whether the image is appropriate on the basis of a facial expression or a gaze direction of the human HM in the image.

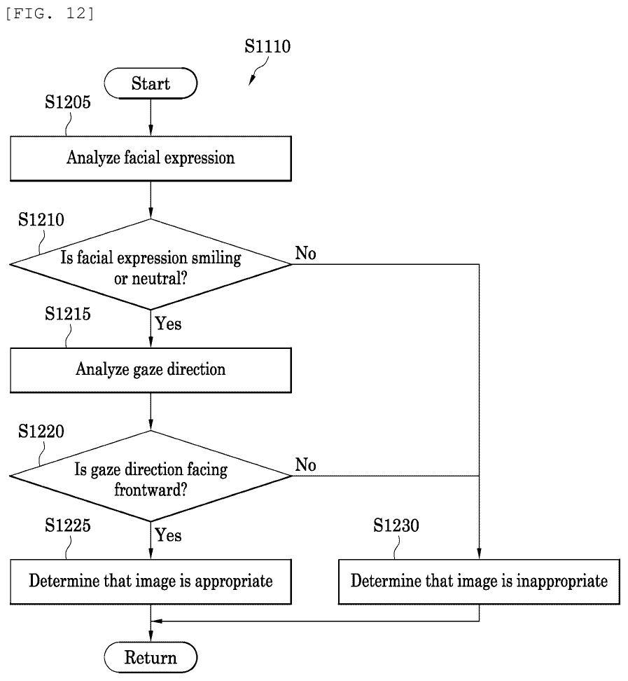

FIG. 12 is a flowchart illustrating a process of inspecting a suitability of the behavior information of the human HM. Referring to FIG. 12, the performing of the suitability inspection on the behavior information of the human HM S1110 includes analyzing the facial expression of the human HM in the image and determining whether the facial expression is an appropriate expression (a smiling expression or a neutral expression) S1210.

In the analyzing of the facial expression of the human HM S1205, a process of extracting a region corresponding to the human HM and the feature region 200 including the object for identifying the facial expression of the human HM from the image. Facial expression information (neutral, smiling, embarrassed, angry, or sad) about a face region of the human HM may be extracted as the behavior information. Various methods including algorithms such as Eigenfaces, Local Binary Patterns (LBP), Convolutional Neural Networks (CNN), and Support Vector Machines (SVM), may be used to analyze the facial expression.

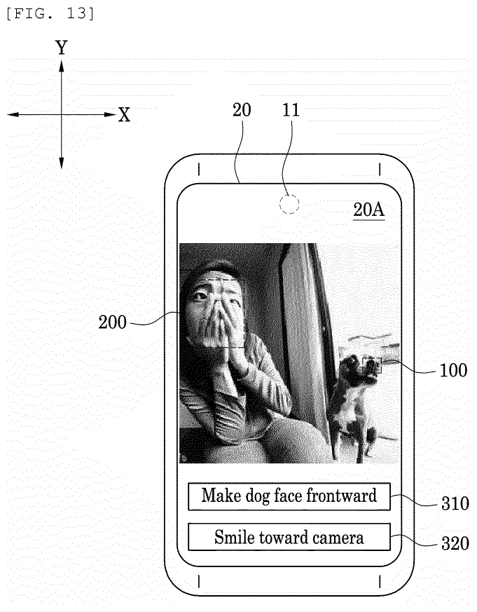

When the facial expression is not an appropriate expression (for example, an angry facial expression or an embarrassed facial expression), the image in which the corresponding face is captured is determined to be unsuitable S1230. For example, as illustrated in FIG. 13, when the facial expression is not detected since the face is covered or when an embarrassed expression is detected, the image is determined to be unsuitable, and a guidance message 320 prompting the human HM to make a smiling expression may be displayed.

When the facial expression is appropriate, analyzing the gaze direction of the human HM S1215 and determining whether the gaze direction of the human HM facing the frontward S1220 are performed. In the analyzing of the gaze direction of the human HM, the eyes within the face region of the human HM may be detected as the feature object, and an algorithm for detecting the gaze direction from an eye image may be performed. For example, the gaze direction may be detected by identifying a position of the pupil within an eye region and comparing the position of the eye and the position of the pupil. An algorithm such as Pupil Center Corneal Reflection (PCCR) may be used to detect the gaze direction.

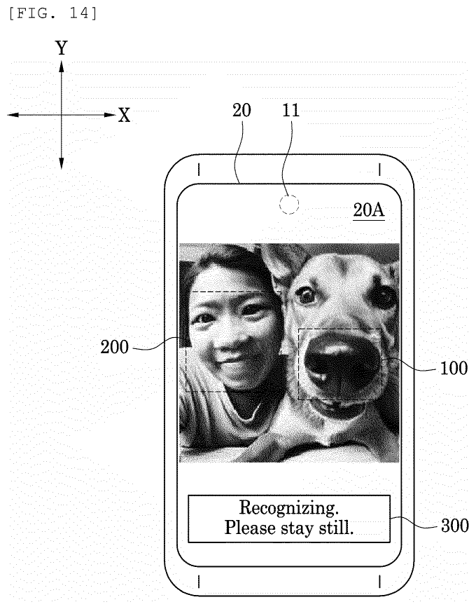

When the gaze direction is determined to be facing the frontward, the captured image is determined to be suitable S1225. When the gaze direction is determined not to be facing the frontward, the captured image is determined to be unsuitable S1230. For example, as illustrated in FIG. 13, when the gaze direction of the human HM faces upward rather than frontward, the guidance message 320 prompting the human HM to look directly at the front side of the camera may be displayed. On the other hand, as illustrated in FIG. 14, when the facial expression is a smiling expression and the gaze direction is facing frontward, the image is determined to be suitable. In this situation, a guidance message 300 prompting maintenance of the same expression and the gaze direction may be displayed.

Although it is illustrated in FIG. 12 that the facial expression analysis is performed first and then the gaze direction analysis is performed, the order may be reversed, or the two analyses may be performed in parallel. Alternatively, only one of the facial expression analysis and the gaze direction analysis may be performed.

Meanwhile, after the image of the feature object for biometric recognition of the companion animal PT is acquired through the front camera 11 or the rear camera 12, a quality evaluation may be performed to determine whether the image of the feature object is suitable for training or identification of the companion animal. According to the present disclosure, the processor 30 may evaluate the quality of the image of the feature object. The conditions defined for evaluating the quality of the image of the feature object may include the clarity, the brightness, and the size. The quality evaluation conditions may vary according to whether the camera capturing the image is the front camera 11 or the rear camera 12. For example, when the image quality is determined on the basis of the size of the image of the feature object, the size condition for the image captured by the front camera 11 may be set to be larger than that for the image captured by the rear camera 12. Generally, the front camera 11 is configured as a camera having lower performance than the rear camera 12. For example, the front camera 11 may provide lower overall image quality that the rear camera 12, and may not support an Optical Image Stabilization (OIS) function which is a hand shake prevention function. Therefore, when the image is captured through the front camera 11, the quality evaluation of the image of the feature object may be performed under stricter conditions than when the image is captured through the rear camera 12. Therefore, the biometric recognition of the companion animal may be smoothly performed even when the image is captured by the front camera 11.

In the captured image, the result of the suitability inspection for the biometric information of the companion animal PT may be displayed on the screen. When the companion animal PT is identified as a dog and the quality evaluation of the feature region 200 including the feature object of the companion animal PT is determined to be unsuitable, a guidance message 310 prompting the dog to look toward the camera may be displayed as illustrated in FIG. 13. When the result of the quality evaluation of the feature region 200 including the feature object of the companion animal PT is determined to be suitable, the guidance message 300 prompting the companion animal PT to maintain the current posture may be displayed as illustrated in FIG. 14.

When both the behavior information of the human HM and the biometric information of the companion animal PT in the image are determined to be suitable, the captured image is stored in the memory 40. The image stored in the memory 40 may be transmitted to the server 2 through the communication module 50.

When the processor 30 of the electronic device 1 transmits the image of the feature object to the server 2, the behavior information of the human HM, the identification information, and the information of the camera capturing the corresponding image may be transmitted together as related information. The server 2 may store and manage the behavior information and the identification information of the human HM and the identification information of the companion animal PT in association with each other. In addition, the server 2 may identify which camera captures the image on the basis of the camera information. The server 2 may determine the method of processing the feature object by using the camera information. That is, the server 2 may process the image differently according to whether the camera capturing the image is the front camera 11 or the rear camera 12.

The present exemplary embodiment and the accompanying drawings in this specification only clearly show a part of the technical idea included in the present disclosure, and it will be apparent that all modifications and specific exemplary embodiments that can be easily inferred by those skilled in the art within the scope of the technical spirit contained in the specification and drawings of the present disclosure are included in the scope of the present disclosure.

Therefore, the spirit of the present disclosure should not be limited to the described exemplary embodiments, and all things equal or equivalent to the claims as well as the claims to be described later fall within the scope of the concept of the present disclosure.

1. A companion animal biometric information acquisition method for selectively storing behavior information of a human and biometric information of a companion animal simultaneously by using an electronic device, the companion animal biometric information acquisition method comprising:
capturing an image containing the human and the companion animal by using a camera provided in the electronic device;
outputting the image through a display;
extracting the behavior information of the human and the biometric information of the companion animal from the image;
determining, on the basis of the behavior information of the human and the biometric information of the companion animal, whether the image is appropriate; and
storing the behavior information and the biometric information in a memory when the image is determined to be appropriate.

2. The companion animal biometric information acquisition method of claim 1,
wherein the capturing of the image comprises capturing the image containing the human and the companion animal primarily by a front camera capturing the image in a direction facing a display direction of the display.

3. The companion animal biometric information acquisition method of claim 2, further comprising:
capturing the image by using a rear camera provided on a side opposite to the front camera instead of using the front camera when the front camera is not capable of being activated.

4. The companion animal biometric information acquisition method of claim 3,
wherein whether the front camera is capable of being activated is determined on the basis of property information of the front camera, and
wherein the property information comprises whether a manual focus function is supported, a capturing format, and a capturing size.

5. The companion animal biometric information acquisition method of claim 1,
wherein the determining of whether the image is appropriate comprises determining, on the basis of a facial expression or a gaze direction of the human, whether the image is appropriate.

6. The companion animal biometric information acquisition method of claim 5,
wherein the image is determined to be appropriate when the facial expression of the human is determined to be a smiling expression or a neutral expression, and the image is determined to be inappropriate when the facial expression is determined to be other than the smiling expression or the neutral expression.

7. The companion animal biometric information acquisition method of claim 5,
wherein the image is determined to be appropriate when the gaze direction of the human is determined to be facing frontward, and the image is determined to be inappropriate when the gaze direction is determined to be facing other than frontward.

8. The companion animal biometric information acquisition method of claim 1,
wherein the determining of whether the image is appropriate comprises evaluating a quality of a feature region containing the biometric information of the companion animal in the image.

9. The companion animal biometric information acquisition method of claim 8,
wherein the quality comprises a sharpness, a brightness, and a size.

10. The companion animal biometric information acquisition method of claim 8,
wherein an evaluation condition for the quality is set differently according to whether the camera is a front camera capturing the image in a direction facing a display direction of the display or a rear camera provided on a side opposite to the front camera.

11. An electronic device for selectively stroing behavior information of a human and biometric information of a companion animal simultaneously, the electronic device comprising:
a camera configured to capture an image;
a display configured to visually output the image;
a processor functionally coupled to the camera and the display; and
a memory functionally coupled to the processor, wherein the processor is configured to:
capture the image containing the human and the companion animal by using the camera;
output the image through the display;
extract the behavior information of the human and the biometric information of the companion animal from the image;
determine, on the basis of the behavior information of the human and the biometric information of the companion animal, whether the image is appropriate; and
store the behavior information and the biometric information in the memory when the image is determined to be appropriate.

12. The electronic device of claim 11,
wherein the camera comprises:
a front camera configured to capture an image in a direction facing a display direction of the display; and
a rear camera provided on a side opposite to the front camera, and
wherein the processor is configured to capture the image containing the human and the companion animal primarily by using the front camera.

13. The electronic device of claim 12,
wherein the processor is configured to capture the image by using the rear camera provided on the side opposite to the front camera instead of using the front camera when the front camera is not capable of being activated.

14. The electronic device of claim 13,
wherein whether the front camera is capable of being activated is determined on the basis of property information of the front camera, and
wherein the property information comprises whether a manual focus function is supported, a capturing format, and a capturing size.

15. The electronic device of claim 11,
wherein the processor is configured to determine, on the basis of a facial expression or a gaze direction of the human, whether the image is appropriate.

16. The electronic device of claim 15,
wherein the image is determined to be appropriate when the facial expression of the human is determined to be a smiling expression or a neutral expression, and the image is determined to be inappropriate when the facial expression is determined to be other than the smiling expression or the neutral expression.

17. The electronic device of claim 15,
wherein the image is determined to be appropriate when the gaze direction of the human is determined to be facing frontward, and the image is determined to be inappropriate when the gaze direction is determined to be facing other than frontward.

18. The electronic device of claim 11,
wherein the processor is configured to detect a feature region containing the biometric information of the companion animal, and is configured to evaluate a quality of an image of the feature region.

19. The electronic device of claim 18,
wherein the quality comprises a sharpness, a brightness, and a size.

20. The electronic device of claim 18,
wherein an evaluation condition for the quality is set differently according to whether the camera is a front camera capturing the image in a direction facing a display direction of the display or a rear camera provided on a side opposite to the front camera.
